(19) United States
(12) Patent Application Publication
(10) Pub. No.: US 2008/0280716 A1
(43) Pub. Date: Nov. 13, 2008

(54) CHAIN FOR USE IN AUTOMOBILE ENGINE

(75) Inventor: Toshihiko Miyazawa, Osaka (JP)

Correspondence Address: HOWSON AND HOWSON, SUITE 210, 501 OFFICE CENTER DRIVE, FT WASHINGTON, PA, 19034, US

(73) Assignee: TSUBAKIMOTO CHAIN CO., Osaka (JP)

(21) Appl. No.: 12/046,712

(22) Filed: Mar. 12, 2008

(30) Foreign Application Priority Data
May 8, 2007 (JP) 2007-123336

(51) Int. Cl. F16G 13/02

(52) U.S. Cl. 474/206

(57) ABSTRACT

In a roller chain or a rollerless bushing chain, the surfaces of the pins of the chain are covered with a chromium carbide layer or a vanadium carbide layer, the bushings are formed by cold forging, and the surface roughness of the pins is smaller than the surface roughness of the bushings.

### CROSS-REFERENCE TO RELATED APPLICATION

This application claims priority on the basis of Japanese patent application 2007-123336, filed May 8, 2007. The disclosure of Japanese application 2007-123336 is hereby incorporated by reference.

### FIELD OF THE INVENTION

The invention relates to power transmitting chains, and to improvements having particular utility in power transmitting chains for use in automobile engines, such as timing chains used for driving intake and exhaust valve-operating camshafts.

### BACKGROUND OF THE INVENTION

The demand for high load capacity, high speed operation, and maintenance-free operation and the need for greater freedom in the design of the layout of engine chains, have all led to the displacement of toothed belts, V-belts and the like in favor of metal roller chains and rollerless bushing chains.

In a bushing chain, pairs of parallel, opposed, inner plates and pairs of parallel, opposed, outer plates are disposed in alternating, overlapping relationship along the length of the chain. A pair of cylindrical bushings is provided for each pair of inner plates, and ends of the bushings are press-fit into bushing holes in the inner plates. A pair of pins is provided for each pair of outer plates, and ends of the pins are press-fit into pin holes in the outer plates. The outer surface of each pin in of a link comprising a pair of outer plates extends through, and fits rotatably in, one of the bushings of a link comprising a pair of inner plates.

A roller chain has the same basic structure as that of a bushing chain. However, in the roller chain, a roller is rotatably mounted on each bushing.

In conventional roller chains and bushing chains, measures have been proposed to reduce wear due to adhesion at the interface between the bushing and the pins, and to improve the tensile strength and other mechanical properties of the pins and bushings. One such measure, described in Japanese Patent Publication No. 3202653, is to form a chromium layer on the surfaces of the pins by subjecting the body of the pin to chromizing treatment, thereby forming a chromium layer from which chromium is diffused into the body material. The chromium layer can have a Vickers hardness of 1000 or more. The surfaces of the pins have minute oil-retaining openings, each having an area corresponding to a circle having a diameter in the range from 0.5 to 15 μm.

The useful life of a conventional chain in an automobile engine is shortened by oxidation and corrosion when the chain is used with deteriorated lubricant, partly because of adhesion of the outer surfaces of the pins to the inner surfaces of the bushings. To address this problem, United States patent publication 2005/0090348 describes a timing chain in which the material of the bushings is carburized stainless steel, and a vanadium carbide layer is formed on the surface of the pins.

However, when the above-mentioned metal chains are used as timing chains in automobile engines, further problems arise. Carbon soot, generated in the combustion process, becomes mixed with the lubricating oil. The grains of this carbon soot have a Vickers hardness of about 1500 HV, and when lubricating oil containing carbon soot enters the gap between a pin and a bushing, abrasive wear is promoted, especially at high speed and high loads, in spite of heat treatment and coating of the pin and the bushing.

Furthermore, carbon soot itself block the formation of an oil film. As a result, abnormal wear, and even seizing, at the interface between a pin and bushing sometimes occurs due to failure of the oil film.

Accordingly, an object of this invention is to solve the above-described problems encountered in the use of conventional chains in automobile engines. It is also an object of the invention to provide a chain for use in an automobile engine, in which wear elongation due to carbon soot mixed into lubricating oil is reduced, and in which abnormal wear due to depletion of the oil film between the pins and the bushings is suppressed.

### SUMMARY OF THE INVENTION

We have extensively studied the suppression of wear between the pins and bushings of a chain when carbon soot is mixed with the chain lubricating oil. As a result, we have determined that the above-mentioned problems can be effectively addressed by controlling the surface roughness of the pins and the bushings, the surface treatment of the pins, and the process of making the bushing. In particular, we have determined that significant improvements can be realized when: (a) a chromium carbide layer or a vanadium carbide layer covers the outer surfaces of the pins; (b) each bushing is cold forged; and (c) the surface roughness of each pin is smaller than the surface roughness of each bushing.

Accordingly, the chain according to the invention comprises pairs of inner plates and pairs of outer plates in alternating, overlapping relationship along the length of the chain. A pair of cylindrical bushings is provided for each pair of inner plates, and ends of the bushings are press-fit into bushing holes in the inner plates. A pair of pins is provided for each pair of outer plates, and ends of the pins are press-fit into pin holes in the outer plates. The outer surface of each pin extends through, and fits rotatably in, one of the bushings. The chain is characterized by a chromium carbide layer or a vanadium carbide layer covering the outer surfaces of the pins, by the fact that each bushing is cold forged, and by the fact that the surface roughness of each pin is smaller than the surface roughness of each bushing.

Preferably, the chromium carbide or vanadium carbide layer is formed by the powder pack method, and the surface roughness of the pins is made smaller than the surface roughness of the bushings by barrel polishing the pins after the pins are covered with a chromium carbide layer or a vanadium carbide layer.

The invention is applicable to not only to rollerless bushing chains, but also to roller chains. In either case, the principal material of the pin and bushing is steel.

According to the invention, in a roller chain or a rollerless bushing chain, when a chromium carbide layer or a vanadium carbide layer covers the outer surfaces of the pins, each bushing is cold forged, and the surface roughness of each pin is smaller than the surface roughness of each bushing, the following peculiar effects of the invention are obtained.

First, fine grain carbon soot in the oil film between the pins and the bushings can escape into recesses in the surfaces of the pins, and carbon soot having a large grain diameter, can escape into recesses in the bushings. As a result, the intervention of carbon soot between mutually sliding surfaces of the pins and bushings is suppressed, and abrasive wear and run out of the oil film are suppressed, so that a longer useful life of the chain can be obtained.

Second, since the surface of the pin is covered by a layer of chromium carbide or vanadium carbide, the materials of the mutually sliding surfaces of pin and the bushing are different from each other. Thus, wear due to adhesion is suppressed, and the suppression of wear due to adhesion further contributes to the extension of the useful life of the chain.

Third, since the bushing is formed by cold forging, there is no cutting of the fiber flow in the bushing, as is the case when a bushing is formed by rolling. Thus, the wear resistance of the bushing is improved. Moreover, the roundness and uniformity of the bushing are improved. As a result, a chain that operates smoothly for a long period of time is obtained.

Fourth, since the surface roughness of the pin is smaller than the surface roughness of the bushing, the contact area of the pin with respect to the bushing is increased. As a result, the surface pressure acting between the pin and the bushing is reduced, and the wear of the bushing is reduced, further contributing to extension of the useful life of the chain.

### BRIEF DESCRIPTION OF THE DRAWINGS

FIG. 1 is a perspective view showing a part of a roller chain according to the invention.

FIG. 2 is a conception view showing a mechanism of the invention

FIG. 3 is test results of a chain elongation in deteriorated lubricating oil for the roller chain of the invention.

### DETAILED DESCRIPTION OF THE PREFERRED EMBODIMENT

In the following description, the invention will be described in the context of a roller chain. It should be understood, however, that a roller chain and a rollerless bushing chain both have pins extending through bushings in a relatively rotatable relationship. Inasmuch as the invention pertains to improvement of the sliding properties at the interfaces between the pins and bushings, the principles of the invention are applicable to both types of chains.

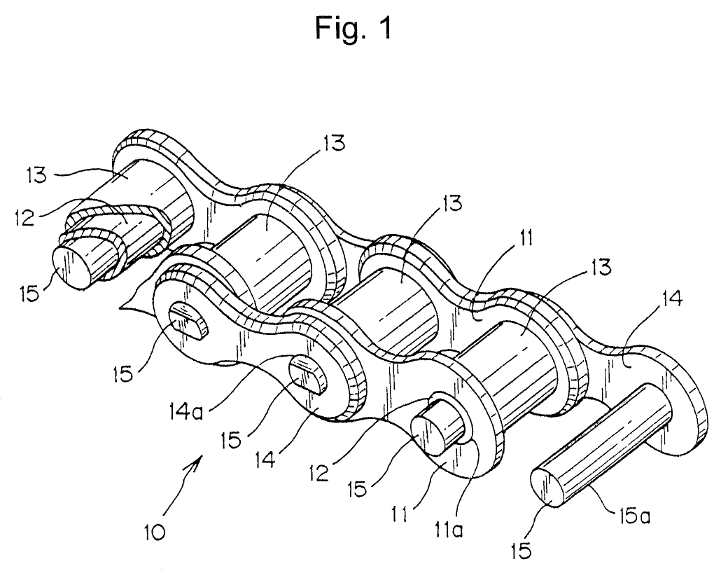

FIG. 1 shows a roller chain 10 in a partially cut-away condition so that the internal structure of the chain can be seen. The opposite ends of each bushing 12 are press-fit into holes 11a formed in a pair of opposed inner plates 11. Similarly, both ends of each pin 15, which extends through a bushing 12 and is rotatable therein, are press-fit into holes 14a formed in a pair of opposed outer plates 14, which are disposed on the outsides of the inner plates in overlapping relationship with the inner plates. Rollers 13 are rotatably mounted on the bushings 12.

The bushing 12 is formed by cold forging. Cold forging is a forging process in which an article is formed at an ordinary temperature, using a metal mold. The use of cold forging results in improvements in the mechanical properties of the bushing. Specifically, since the structure of the material is “fined,” i.e., compressed, in the process of cold forging, and the fiber flow of the metal is not cut, as would occur if the bushing were made by rolling or by other conventional processes, the wear resistance of a bushing formed by cold forging is superior to that of a bushing formed by rolling.

The bushings 12, which are formed by cold forging, are preferably subjected to a surface treatment in which metal powder, referred to as “shot,” is projected by jets toward the surfaces of the bushings. The bushings are then subjected to polishing by rotation in a solvent containing a polishing medium to reduce the surface roughness of the bushings. The polishing process both decreases the surface roughness of the bushings and removes scale, that is, the oxide film formed on the bushing surface during cold forging.

The surface roughness values Rz referred to herein are ten-point mean values determined by following Japanese Industrial standard JIS 0601-1994. In accordance with that standard, the surface roughness Rz is obtained by selecting five peaks and five bottoms, and determining a mean height.

In the case of a bushing in a chain according to the invention, the surface roughness Rz is preferably in the range from 0.4 to 2.0 μm, and more preferably in the range from 0.5 to 1.5 μm.

For the pin 15 will be described. First, the surface 15a (FIG. 1) of a pin having a body material composed of steel, is covered with a chromium carbide layer or a vanadium carbide layer using, for example, diffusion penetration treatment. Diffusion penetration treatment is preferably carried out by the well-known method referred to as the “powder pack” method, in which the pins 15 are embedded in chromium or vanadium powders or powders composed of alloys of chromium or vanadium, and heated to a high temperature for a required time interval. However, the diffusion penetration treatment is not limited to the powder pack method. Besides this method, the “molten salt” method, or the so-called “application method” can be utilized. In the molten salt method, the pin is treated in molten salt. In the “application method,” a chromium powder, and a suspending agent with added coating material or the like, are applied to the pin, and pin is dried and heated in inert gas or in a vacuum. The “powder pack” method is preferred because it is inexpensive and especially suitable for treatment of small articles such as pins 15.

The surface roughness of the pins 15, which are covered with a chromium carbide layer or a vanadium carbide layer, is made smaller than the surface roughness of the bushings 12. Specifically, the surfaces of the pins 15 are preferably polished so that the ten point mean roughness (Rz) is in the range from 0.1 to 0.3 μm. Various polishing methods can be used. However, a preferred polishing method is barrel polishing, in which the pins to be polished are put into a barreling vessel together with a granular polishing material and a solvent, and polishing is performed by rotation and vertical movement of the barreling vessel. Since the use of this method causes relative friction between the pins 15 and the polishing material in the barreling vessel, polishing of a small articles such as pins 15 can be carried out efficiently.

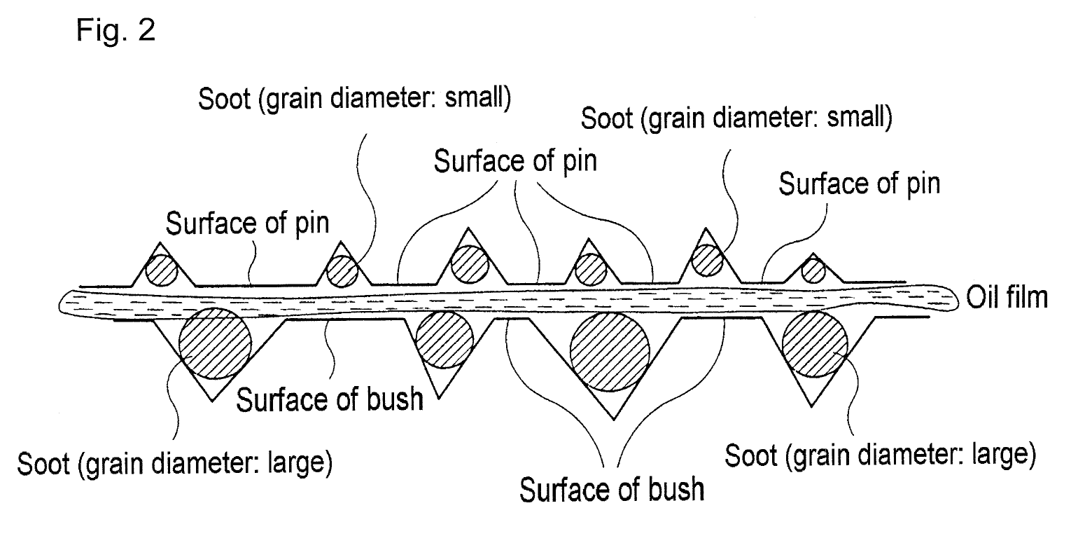

The mechanism by which the generation of abrasive wear and run out of the oil film are avoided by making the surface roughness of the pin smaller than the surface roughness of the bushing not fully understood. However, with reference to FIG. 2, the following is a possible explanation.

The carbon soot grains generated in the combustion process in the engine are small, typically having a diameter around 50 nm. This carbon soot, together with lubricating oil, enters into the gaps between the pins and the bushings. The carbon soot having a small grain diameter gradually adheres and grows in the gap between the pin 15 and the bushing 12 to a size such that it can just fit into the recesses of the surface of the pin, and becomes slightly deformed so that it fits the shape of the recesses. Thus, this carbon soot is trapped by the recesses in the surface of the pin, without leaving the gap between the pin and the bushing.

On the other hand, carbon soot that adheres to some extent before entering the gap between the pin and the bushing and is of a size such that it cannot fit into the recesses on the surfaces of the pins, further adheres and grows in the gaps between the pins and the bushings. When This carbon soot is of a size such that is just fits into the recesses of the surface of the bushing and is slightly deformed so that it fits the shapes of the recesses. Here again, the carbon soot is trapped by the recesses of the bushing, without leaving the gaps between the pins and the bushings.

When the carbon soot that adheres to some extent before entering the gaps between the pins and the bushings is of a size such that it cannot fit into the recesses in the surfaces of the bushings, it naturally cannot enter the gaps between the pins and the bushings, and cannot generate abrasive wear, or cause run out of the oil film. Thus, these large size carbon particles do not cause problems.

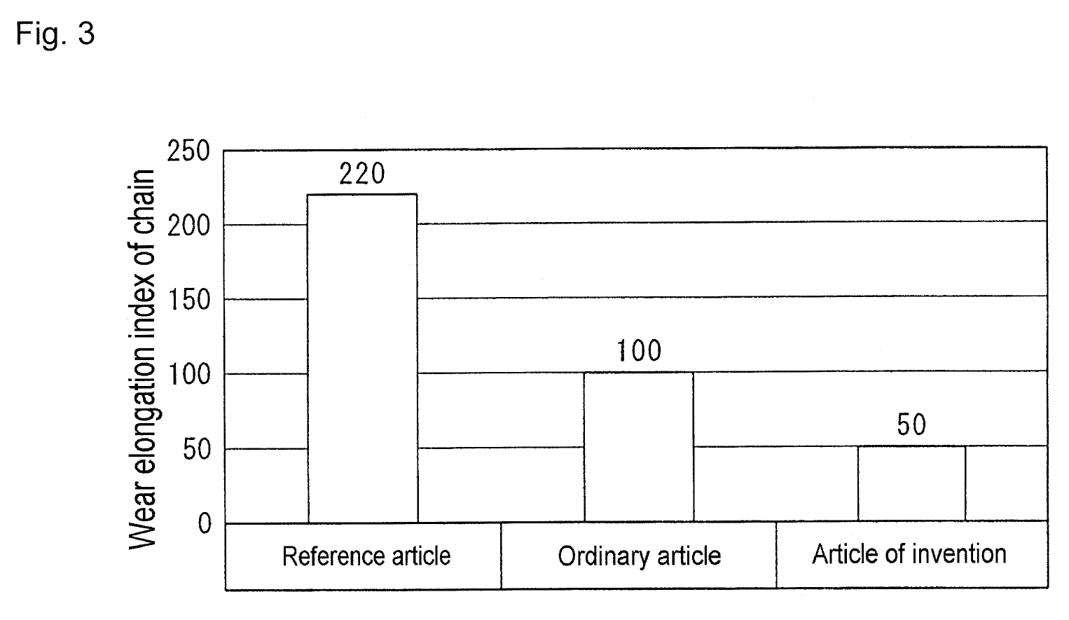

In order to measure the properties of a chain according to the invention, wear elongation tests were performed, and the results are shown in FIG. 3. The wear elongation indices of the chains are compared on a scale in which the wear elongation of an ordinary chain, is set to 100. A higher wear elongation index corresponds to a greater degree of wear elongation. The tests were carried out under the following test conditions:
Chain: Roller chain having a pitch of 8 mm
Number of teeth on sprockets: 18×36
Rotation speed: 7000 r/min
Lubricating oil: oil with carbon soot added
Amount of oil: 1 L/min

The comparison of an article according to the invention, an ordinary article, and a reference article, depicted in FIG. 3, is based on the results of a chain elongation test made using a general motoring test machine. The method used is one generally used in the art, and similar results can be expected when using alternative test methods.

The ordinary article utilizes a bushing formed by rolling. The surface roughness Rz of the bushing is in the range from 2.0 to 3.0 μm. The pin has a chromium carbide layer or a vanadium carbide layer formed on the surface, and the surface roughness Rz of the pin is in the range from 0.3 to 0.8 μm.

In the reference article, again the bushing is formed by rolling, and has a surface roughness Rz greater than 3.0 μm. The pin has a chromium carbide layer or a vanadium carbide layer formed on its surface, and has a surface roughness Rz larger than 0.8 μm.

In the article according to the invention, the bushing is formed by cold forging, and has a surface roughness Rz in the range from 0.4 to 2.0 μm. The pin has a chromium carbide layer or a vanadium carbide layer formed on its surface, and the surface roughness Rz is in the range from 0.1 to 0.3 μm.

As is apparent from the results shown in FIG. 3, the wear elongation index of the chain according to the invention was reduced to about one half that of the ordinary article. Furthermore, in the reference article, which has large values of surface roughness in both the pin and the bushing, even if carbon soot escapes from the sliding surfaces, the high surface hardness of the pin promotes wear of the bushing. Thus, the wear elongation index of the reference article is even greater than that of the ordinary article.

### INDUSTRIAL APPLICABILITY

It has been recognized that wear elongation of chains for automobile engines can be improved by reducing the roughness of the pins of the chain. However, we have now determined that, when a chain for an automobile engine is used under an environment where there are inclusions such as soot in the lubricating oil, wear elongation can be more effectively suppressed by providing a difference in the relative surface roughnesses of the pin and bushing, and specifically by making the surface roughness of the pin smaller than the surface roughness of the bushing. This invention has significant industrial applicability especially in that it allows wear elongation of a chain to be reproducibly improved without the use of a special production facility and expensive materials.

What is claimed is:

1. A chain for use in an automobile engine comprising:
pairs of inner plates and pairs of outer plates in alternating, overlapping relationship along the length of the chain;
a pair of cylindrical bushings for each pair of inner plates, ends of the bushings being press-fit into bushing holes in the inner plates; and
a pair of pins for each pair of outer plates, ends of the pins being press-fit into pin holes in the outer plates, each pin having an outer surface, and extending through, and fitting rotatably in, one of said bushings;
wherein the surface of each said pin is covered with a chromium carbide layer or a vanadium carbide layer, each said bushing is a cold forged bushing, and the surface roughness of each said pin is smaller than the surface roughness of each said bushing.

2. A chain according to claim 1, in which the surface roughness of the pins is made smaller than the surface roughness of the bushings by barrel polishing the pins after the pins are covered with a chromium carbide layer or a vanadium carbide layer.

3. A chain according to claim 1, in which the chromium carbide or vanadium carbide layer is formed by the powder pack method.

4. A chain according to claim 3, in which the surface roughness of the pins is made smaller than the surface roughness of the bushings by barrel polishing the pins after the pins are covered with a chromium carbide layer or a vanadium carbide layer by the powder pack method.
